(19) United States
(12) Patent Application Publication
(10) Pub. No.: US 2004/0055004 A1
(43) Pub. Date: Mar. 18, 2004

(54) Method for efficient process state transfer between two computers using data transfer mechanisms embedded to the migration-enabled process

(76) Inventors: Xian-He Sun, Darien, IL (US); Kasidit Chanchio, Knoxville, TN (US)

Correspondence Address: Roland W. Norris, Pauley Petersen Kinne & Erickson, Suite 365, 2800 West Higgins Road, Hoffman Estates, IL, 60195, US

(21) Appl. No.: 10/409,286

(22) Filed: Apr. 8, 2003

Related U.S. Application Data
(60) Provisional application No. 60/376,583, filed on Apr. 30, 2002.

(51) Int. Cl. G06F 9/00

(52) U.S. Cl. 718/108

(57) ABSTRACT

The source code of a migration able program is precompiled to insert possible migration points, and collection, transfer, and restoration macros associated with the possible migration points, with the functions analyzed or mapped in order that the function sequence of the actually migrating process, i.e., the execution state, can be collected from its most recent, or inner-most, function to its main, or outer-most function, and transferred and restored in the same order to the destination computer. The collection, transfer and restoration can be carried out concurrently for optimal performance. The memory state necessary to accomplish the functions of the migrated process is mapped and reconstructed in the destination computer so as to be collected, transferred and restored in the same order as the execution state sequence. The collection, transfer and restoration processes can be carried out concurrently for greater migration efficiency.

### BACKGROUND OF THE INVENTION

The present invention relates to a mechanism that governs the collection, transfer, and restoration of execution status and data contents, sometimes also referred to as execution state and memory state, of a migrating process during process migration between two homogeneous or heterogeneous computers.

Process migration is a basic function necessary for dynamic computer processing management in distributed computing. Process migration moves a process running on one computer to another computer over a network. A “process” is defined as at least a piece of a computer program which is in operation. The term “computer” is defined as those components necessary to accomplish the running of a process, including but not limited to a processor, executable software routines, and memory. Thus, the term “computer” implies a location, or locations, where the process may operate. A “machine” refers to a particular computer operating with a particular hardware and software platform. One “workstation” may contain one or more computers and may run one or more “processes.” Migration, as stated above, will involve the transfer of processing operations from a first computer to a second computer via a network. The person having ordinary skill in the art will understand that in a distributed computing environment, the computers may be, but are not necessarily, physically separated. The process migration would ideally be available through either of a network of similar computers (homogeneous process migration) or over computers with different hardware/software environments (heterogeneous process migration). Motivations for process migration may include, for example, processor load balancing, fault tolerance, data access locality, resource sharing, reconfigurable computing, system administration and high performance achieved by utilizing unused network resources. Process migration can also be used for portability such as migrating processes from one computing platform to an upgraded one. For example, enabling cellular computing from hand held devices may be especially suited for using process migration.

However, despite the need for these advantages, process migration has not been widely adopted due to its design and implementation complexities, especially within a network of heterogeneous computers.

Process migration has been implemented in the past using a user-level checkpointing technique to generate a checkpoint file, which stores the process state and can later be used to resume process execution. This technique is currently important for homogeneous and heterogeneous process migration and has been adopted by most migration-supported software systems. Traditionally, for fault-tolerance, the checkpoint file is saved to a file system where the file can be retrieved to resume process execution from the last checkpoint in case a fault occurs to a checkpointed process.

There are currently two common approaches to migrate a process developed on stack-based languages like C or FORTRAN between two homogeneous or heterogeneous computers. Both approaches use compilation techniques to prepare the process for migration.

In the first approach, compilers are modified to generate additional debugging information that can assist process migration at runtime. The works of F. B. Dubach and R. M. Rutherford and C. M. Shub, in the article “Process-Originated Migration In A Heterogeneous Environment,” The Proceeding of ACM Conference on Computer Science, ACM, New York, 1989; and C. M. Shub, in the article “Native Code Process-Originated Migration In A Heterogeneous Environment,” ACM Conference on Computer Science, ACM, New York, pp. 266-270, 1990; are along this direction. However, these process migration implementations depend on a specifically modified compiler and the V operating system as detailed in D. R. Cheriton, “The V Distributed System,” Communication of the ACM, Vol.31, No.3, pp.314-333, 1988. The work of P. Smith and N. Hutchinson, “Heterogeneous Process Migration: The TUI System,” Tech Report No. 96-04, Department of Computer Science, University of British Columbia, Feb. 1996 (revised 1997); follows this direction as well. Although this process migration method is independent of operating systems, it still relies on a particular modified compiler. Because this approach requires all computers to use the same compiler, it is impractical since various vendors may provide different compilers for various platforms within the distributed computing environment. More comparisons can be found in K. Chanchio, “Efficient Checkpointing for Heterogeneous Collaborative Environments: Representation, Coordination, and Automation” Ph.D. Dissertation, Department of Computer Science, Louisiana State University, 2000.

In the second common approach, program annotation techniques are employed to support process migration. The works of Adam J. Ferrari and Stephen J. Chapin and Andrew S. Grimshaw, “Process Introspection: A Checkpoint Mechanism for High Performance Heterogeneous Distributed Systems,” Tech Report No. CS-96-15, Department of Computer Science, University of Virginia, October 1996; V. Strumpen and B. Ramkumar, “Portable Checkpointing and Recovery in Heterogeneous Environments,” Tech Report No. 96-6-1, Department of Electrical and Computer Engineering, University of Iowa, June 1996; and applicants' previous work, K. Chanchio and X.-H. Sun, “Efficient Process Migration for Parallel Processing on Non-Dedicated Network of Workstations,” Technical Report No. 96-74, ICASE, NASA Langley Research Center, 1996; are along this direction. These works have adopted similar methods of source code annotation and similar checkpointing mechanisms to transfer a process state across homogeneous or heterogeneous machines.

The known mechanisms have a common design drawback, which can be improved for better process migration performance in networking environments. In the known checkpointing designs, the process state of the migrating process, when a nested function call or a recursion, is collected and restored in a stack-like manner. This mechanism may be referred to as “the stack-like data transfer mechanism.” The mechanism starts collecting the migrating process state from the innermost function of a nested function and retreats to the main function, while it restores the process state information in the destination computer in reverse order to which it is collected. As a result, the process state restoration can only start working on the destination computer after the collection on the migrating process computer finishes and the migration operations cannot perform the collection, transfer, and restoration operations concurrently. One such example of the stack-like data transfer mechanism can be seen in U.S. Pat. No. 6,161,219, entitled System And Method For Providing Checkpointing With Precompile Directives And Supporting Software To Produce Checkpoints, Independent Of Environment Constraints.

Because each of the known methods suffers certain inefficiencies in the distributed computing environment there is a need in the art for a method to promote faster process state transfer across machines in homogeneous or heterogeneous distributed computing environments.

### SUMMARY OF THE INVENTION

The present invention proposes a new method, namely a “buffered data transfer” method, to collect, transfer, and restore the process state directly via networks between two computers that have the same or different hardware, operating systems, and compilers. This method is implemented to the process by inserting a set of macros to various locations in source code. Therefore, the method is embedded to the process and will perform a process state transfer as internal operations of the process without assistance of any external agents. The exemplary embodiments disclosed herein are particularly suitable for stack-based languages such as C, FORTRAN, or C++.

In order to accomplish the improvements of the buffered data transfer system a precompiler is used to embed poll points in the source code. The poll points are places at which migration of the process may occur from a first, or source, machine to a second, or destination, machine. In relation to the poll points, macros are placed in the source code to manage the process state migration according to the same order of collection, transfer and restoration for both machines. The memory state of the process is further constructed to be independent of particular machine types in order to facilitate efficient heterogeneous distributed computing.

In the exemplary design, a program must be transformed into a ‘migratable’ format. As introduced in applicants' previous work, K. Chanchio and X.-H. Sun, “Efficient Process Migration For Parallel Processing On Non-Dedicated Network Of Workstation,” Technical Report 96-74, NASA Langley Research Center, ICASE, 1996; source code annotation is applied to insure the program is migration capable. In the annotation process, a number of locations are first selected in the source code on which process migration can be performed. Such a location is called a “poll point.” At each poll point, a label statement and a specific macro containing migration operations are inserted. Every time the process execution reaches the poll point, the macro will check whether a migration request has been sent to the process. If so, the migration operation is executed. Otherwise, the process continues normal execution. The poll point where the migration occurs is referred to as the “migration point.” The migration operations include the operations to collect the execution state and live-variable data of the migrating process in an order from innermost to outermost functions, and the operations to restore them in the same order on the memory space of a process on another machine. In the exemplary design, the selection of poll points and the insertion of macros are performed automatically by the source code transformation software, or pre-compiler. Users can also select their preferred poll points if suitable migration locations in their source codes are known.

The pre-compiler comprises different phases of program analysis and source code annotation mechanisms. The program analysis techniques comprise poll-point analysis and live-variable analysis. The poll-point analysis identifies poll-point locations in source code by investigating the body of each function. If one or more poll points are selected in a function, whether manually or automatically, the poll-point analysis will identify mandatory poll points at every function call statement made to the function. The reason for this is to identify a sequence of function calls when a migration is performed at any selected poll point.

In the case of function pointers, it is assumed that the pointers could invoke any function, including those that have poll points. As a result, a mandatory poll point is inserted at every function call statement to a function pointer in the source code. After selected poll points have been identified, live-variable data analysis is applied to the selected poll points to define a set of variables whose values are needed for future computation. For mandatory poll points, a slightly different technique is used wherein live-variables are defined at the location right after the function call statement, rather than at the location where the call statement is made. The reasons for this are further discussed below.

Finally, the pre-compiler annotates a set of macros into various locations in the source code. For a selected, i.e., non-mandatory, poll point, macros are inserted to collect and restore data values of live-variables, i.e., catalog the live-variable data. For a mandatory poll point, first and second macros are inserted immediately before and after the function call statement, respectively. The first macro keeps a record of the function calling. The second macro performs the data collection and restoration of the live-variables identified from the live-variable analysis at the mandatory poll point. The first and second macros work together during process migration to perform a data-transfer mechanism as discussed below.

In a process migration environment of the present invention, it is assumed that the source program has been pre-distributed and compiled on potential destination machines. A distributed environment is modeled to have a scheduler, which performs process management and sends a migration request to a process. The scheduler conducts process migration directly via a remote invocation and network data transfers. First, the process on the destination machine is invoked to wait for the execution state and the live-variable data of the migrating process. Then, the migrating process collects this information and sends it to the waiting process. After successful transmission, the migrating process terminates. Concurrently, the new process receives the execution state and live-variable data information, restores it on appropriate memory locations, and resumes execution from the point where process migration occurred.

A data collection and restoration mechanism such as set forth in U.S. Pat. No. 6,442,663 to Sun et al., which is hereby incorporated by reference in its entirety, may be used to enable data transfer compatible with an execution state transfer mechanism according to the present invention. According to the Sun et al. patent, data migration process mechanism based on a logical memory model can be enabled by machine-independently representing memory blocks and pointers in process memory space.

The present invention provides, without limitation, the improvements of faster process migration between homogeneous or heterogeneous computers than existing homogeneous or heterogeneous process migration methods; and provides overlapping computation and communication functions such that process state collection, transfer, and restoration can be performed concurrently.

### BRIEF DESCRIPTION OF THE DRAWINGS

FIG. 1 is a schematic representation of the migration process between a source computer and a destination computer of a virtual machine according to certain aspects of the present invention.

FIG. 2 is a block diagram of precompiler operations for annotation of source code according to certain aspects of the present invention.

FIGS. 3-5 are a representation of source code annotation and Macro insertion utilizing the Map and Mod files of FIG. 2.

FIGS. 6-10 are representations of five migration-enabling macros according to certain aspects of the present invention.

### DESCRIPTION OF THE PREFERRED EMBODIMENTS

Generally, the buffered data transfer mechanism of the present invention governs the collection, transfer, and restoration of execution status and memory contents, sometimes also referred to as execution state and memory state, of a migrating process during process migration between two networked homogeneous or heterogeneous computers. Aspects of the invention are particularly useful when multiple or nested function calls are necessary to the process being migrated.

The invention can be implemented to a process by inserting a set of macros to various locations in the process source code. Therefore, the mechanism can be embedded to the process and will perform the process state transfer for the process migration as internal operations of the process without assistance of any external agents, thereby enhancing the efficiency of the process migration.

In the exemplary buffered data transfer, the operations involve a migrating process on the source computer, a destination, or initialized process on the destination computer, and a network connection between the two processes. The method includes keeping track of the migration point and the function call sequence of the migrating process when a migration occurs. When the migration starts, the initialized process, which is equipped with a method for process state restoration, is loaded on the destination computer to wait for process state information. The following description is of an exemplary process state collection, transfer, and restoration method.

As will be recalled, a “process” is a piece of a program, or software, which is running. Consequently, the terms “process” and “program” may sometimes be used interchangeably herein. A “function” will be used in the sense of a particular process or subroutine of the process used to derive a datum or data necessary for the solution of the overall process. For example, main function, Fmain, is a process which, in the course of its running, calls upon function F1 to perform its subroutine function to provide data to Fmain. In order to arrive at the F1 subroutine data, F1, in the course of its running, calls upon a subroutine F2 to perform its subroutine function to provide necessary data to F1. Once F2 supplies its data to F1, F1 can finish its subroutine and supply data to Fmain. Fmain can then finish its process, or its particular function within a larger process. In this example F2 is thus the “innermost” function.

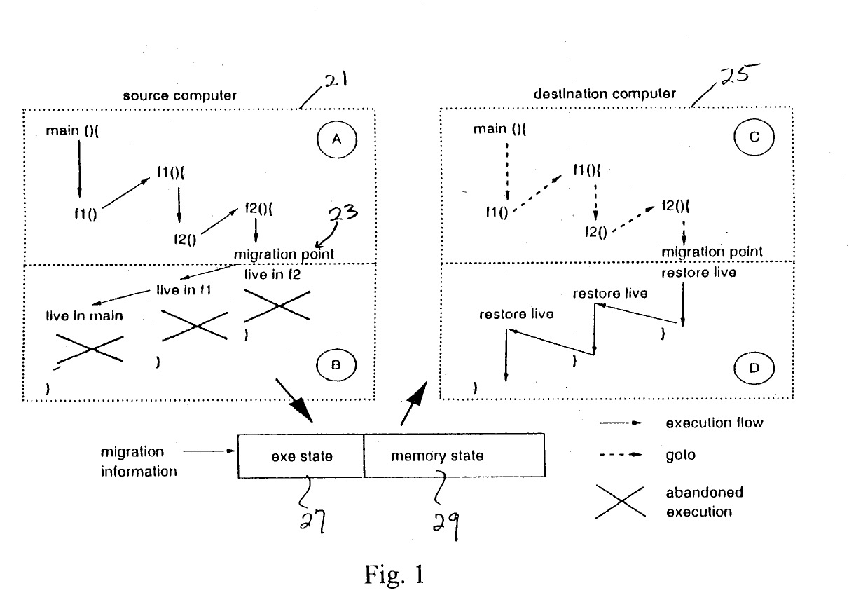

Referring to FIG. 1, there is shown an example of process migration from a source computer to a destination computer. A function call sequence of main->F1->F2 means the main function calls function F1, and function F1 calls function F2. A migration is shown as occuring within F2. The “live-variable data” are then collected in the order of functions F2, F1, and main accordingly. The “live-variable data” of a particular function are the data needed for future execution of that function after the migration finishes.

From FIG. 1, when program execution of the source computer 21 reaches the migration point 23 in F2, the annotated migration operations, as further explained below, recognize the sequence of function calls as the execution state, make a network connection to the initialized process on the destination computer 25, and send the execution state (exe state) information to the initialized process as indicated at reference number 27. The initialized process receives the execution state and then makes a series of function calls to reconstruct the function call sequence similar to that of the migrating process. Thus, the function call sequence, main->F1->F2, on the initialized process in FIG. 1 is recreated at this step.

After the reconstruction of the function call sequence in the initialized process, the data restoration operations at the migration point 23 transfer live-variable data of the innermost function, F2, over the network to the initialized process. This is also termed “memory state transfer” as indicated at ref. no. 29. Then, the initialized process restores the live-variable data and resumes execution until the function finishes. Thus, in FIG. 1, after sending the execution state, the migration operations in the migrating process collect the live-variable data of F2 and send it over the network to the destination process before returning to F2's caller function, F1. Note that the rest of the execution in F2 is abandoned in the source computer 21.

Next, the F1 live-variable data are collected from the process on the source computer 21 and transmitted to the initialized, or new, process at the destination computer. F1 (on source computer 21) abandons the rest of its execution and returns to its caller function, main. Then, the migration operations collect the main function live-variable data, send it to the destination computer 25, and terminate the original migrating process.

After receiving the live-variable data of F2 (from the migrating process on source computer 21), function F2 on the second computer 25 restores its live-variable data and resumes operations until finish and returns to its caller function, F1. Then, the restoration operation on F1 is operated to restore live-variable data of F1 transmitted from the source computer 21. After the restoration, F1 resumes its operation until finish and returns to the main function. The data restoration operation on the main function is then performed to receive live-variable data (of function main) transmitted from the source computer 21, restore the data, and resume computation in the main function.

In the exemplary implementation, the buffered data transfer method is incorporated to a process by annotating the additional migration operations into the user source code in the form of macros, as further explained below.

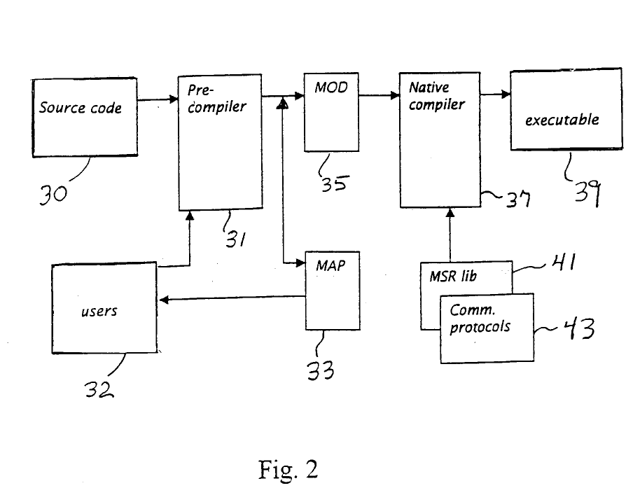

FIG. 2 illustrates basic steps for software development according to aspects of the present invention within the migration environment. The embedding of the buffered data transfer mechanism to the process is designed to be a part of the software development environment for homogeneous or heterogeneous process migration. In the exemplary design, users 32 may pass their source code 30 to a pre-compiler 31 to generate the migration-supported code. The pre-compiler 31 may be source-to-source transformation software which performs program analysis and annotation on user source code 30. Some parts of the precompiler may be used for program instrumentation, i.e., annotating special code to measure performance of program execution. Other parts of the precompiler may be a known language preprocessor such as a “cpp” (“C language PreProcessor”) which comes with most commercially available C compilers, including a publicly available C compiler from the GNU Project (www.gnu.org), and is used for expanding macros or to include statements in C. The pre-compiler 31 acts upon the source code to generate two output files, a map file (MAP) 33 and a modified file (MOD) 35.

During program analysis, users 32 may select locations in the source code where a process migration can be performed, i.e., the users may annotate their source code with selected poll points. The precompiler will then automatically add mandatory poll points. Locations where migration may occur are individually called a “poll-point.” The MAP file 33 shows, or records, locations of the poll-points and live-variable data analysis points.

The MOD file 35 is an annotated source code to enable process migration and is generated from a MAP file 33 the user has approved. If the users 32 do not like the selected poll-points, they can reconfigure the MAP file 33 and let the pre-compiler 31 generate a new MOD file 35. After the users 32 have approved the poll point selection, the MOD file 35 may be distributed to a destination computer of a process migration as a machine-independent executable. Alternatively, the poll point locations may be selected automatically. Then, the MOD file 35 can be passed to a native compiler 37 to generate a migration-supported executable 39. At this step, the migration-supported executable 39 is also linked to a memory space representation runtime library (MSR lib) 41, as further explained in U.S. Pat. No. 6,442,663 to Sun et al., and a data communication runtime library (Comm. Protocols) 43 for reliable data communication and process migration protocols such as discussed in Applicants' co-pending application 10/293,981 filed 13 November 2002.

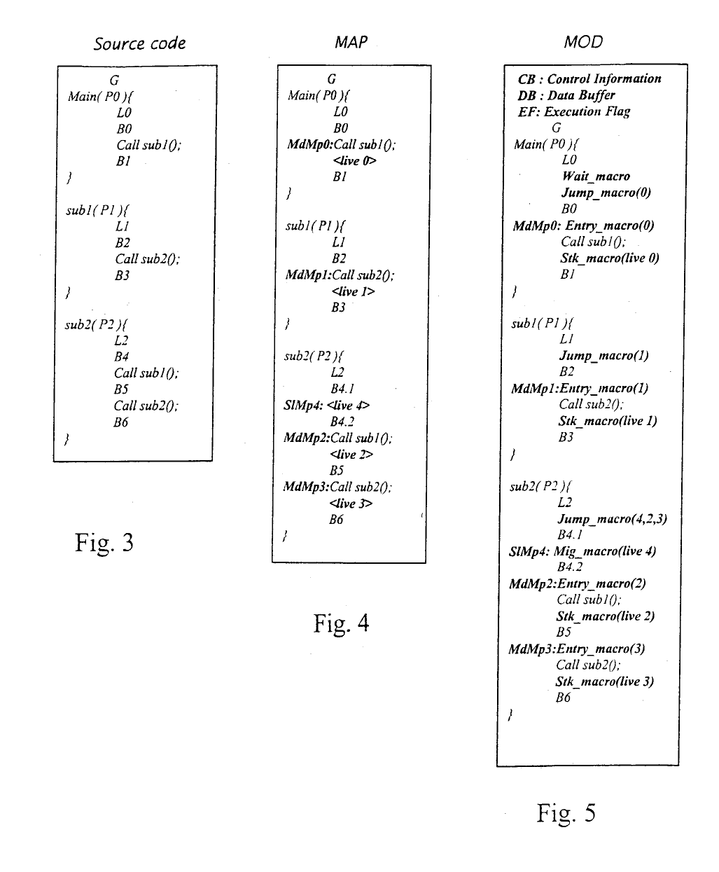

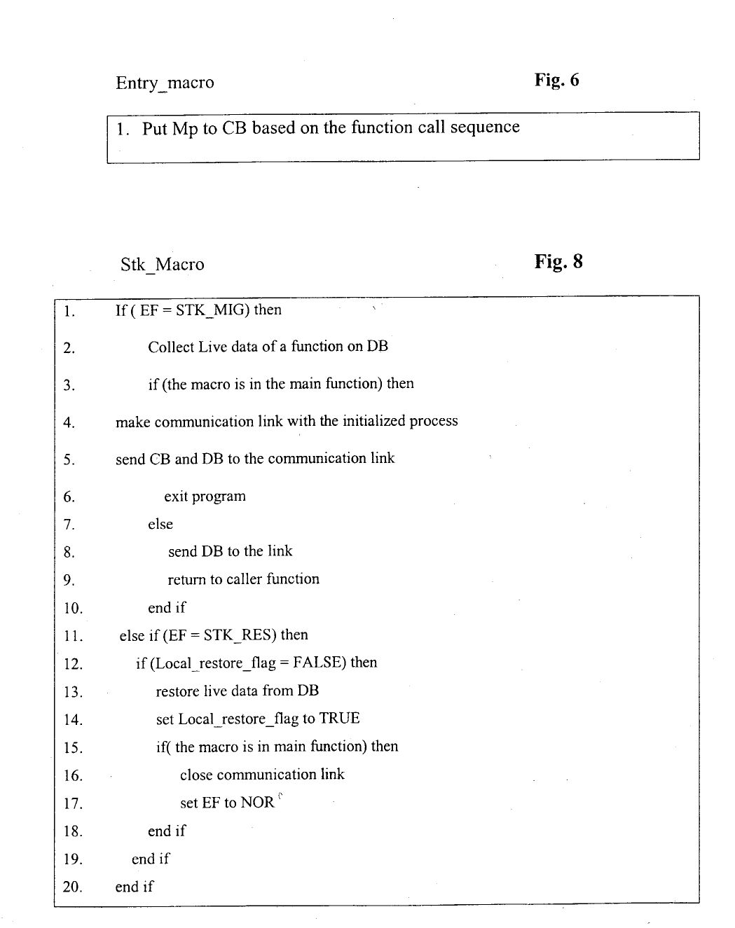

FIGS. 3-5 illustrate the insertion of macros to perform process migration on an example stack-based program. FIG. 3 shows examples of a source file, while FIGS. 4 and 5 show its MAP and MOD files, respectively, under an exemplary annotation mechanism. In FIG. 3, G denotes the global declaration segment of the source code. Px, where x ∉{0,1,2}, is a set of formal parameters of a function. Likewise, Lx, where x ∉{0, 1, 2}, represents the local variable declaration section of a function. In the body of the functions, Bx, where x ∉{0,1, . . . , 6}, denotes a sequence of instructions. Note in FIG. 4 that the sequence of instructions B4 are split into two parts, B4.1 and B4.2.

The pre-compiler 31 (FIG. 2) employs a poll point and live-variable analysis to the source code of FIG. 3 to generate the MAP file shown in FIG. 4. In this example, it is assumed that the pre-compiler has annotated the selected poll point s1Mp4 in the first phase of the poll point analysis. Then, the poll points, here labeled mandatory poll points mdMp0, mdMp1, mdMp2, and mdMp3; are inserted in the second phase of Map file construction. The insertion of a mandatory poll point is different from the selected poll point in that the mandatory poll points are inserted before their corresponding subroutine calls, but the corresponding live-variable data analysis definition is inserted at the point immediately after the subroutine, or function, calls. For instance, the mandatory poll point mdMp0 is inserted before the subroutine call to sub1( ), but its corresponding set of live-variables <live0>is defined after the function call. For the selected poll point, S1Mp4, live-variable analysis <live 4>is performed at the annotated location, i.e., the live-variable set <live4>is defined at the insertion point of slMp4.

To generate a MOD file as shown in FIG. 5, global variables and migration-enabling macros are annotated to the MAP file. The global variables include: a Control Buffer (CB), a Data Buffer (DB), an Execution Flag (EF), and other variables such as those for reliable data communications at the top of the file.

Each macro annotated to the source code, as illustrated in FIGS. 6-10, works according to a value of the EF variable. The EF represents the execution status of the process at a certain point of program execution. Its alternation is performed by signaling between the process and the scheduler and by operations inside the buffered data transfer macros.

Seven types of EF values: normal (NOR), waiting (WAIT), migration (MIG), migration of activation record stack (STK_MIG), jump (JUMP), restoration (RES), and restoration of activation record stack (STK_RES) are defined.

1. The NOR flag, the default value, represents normal execution of the process.

2. The WAIT flag is assigned to the EF of the initialized process by the scheduler to wait for a communication connection from the migrating process.

3. The MIG flag tells the process to start its migration at the nearest coming selected poll point.

4. In case nested function calls occur at a migration, the EF is set to STK_MIG during the data collection operation of the caller functions.

5. The JUMP flag is set in the initialized process after CONTROL BUFFER and DATA BUFFER are transmitted. It causes the process to transfer its execution to a particular poll point using a sequence of goto statements.

6. The RES flag is set when the execution of the initialized process is transferred to the (selected) poll point that causes process migration. This triggers the restoration of live-variable data of the function that the poll point belongs to.

7. The STK_RES is set in the initialized process when live-variable data of the caller functions is restored in presence of nested function calls during the migration.

After inserting variables, the pre-compiler inserts migration-enabling macros at necessary locations over the program. The migration-enabling macros include: Entry_Macro, Mig_Macro, Stk_Macro, Wait_Macro, and Jump_Macro.

The pre-compiler inserts a Wait_Macro at the beginning of the Main function to wait for the migration communication connection to the destination machine and wait for the contents of the Control Buffer and Data Buffer from the migrating process. A Jump_Macro is put right after the Wait_Macro in the Main function and at the beginning of the body of other functions, sub1(P1) and sub2(P2). A Mig_Macro is inserted at every selected poll point. In the case of the mandatory poll points, an Entry_Macro is inserted immediately before the function call associated to the mandatory poll point and a Stk_Macro is inserted right after the function call.

1. Entry_Macro: As seen in FIG. 6, the Entry_macro keeps track of a function call sequence in a nested function call before process migration take place. The precompiler inserts this macro at every mandatory poll-point before the function call statement. At runtime, the macro appends the name of the poll-point, e.g. Mp in FIG. 6, to the end of the CONTROL BUFFER, which will later be transmitted to the initialized process by the Mig_macro or Stk_macro.

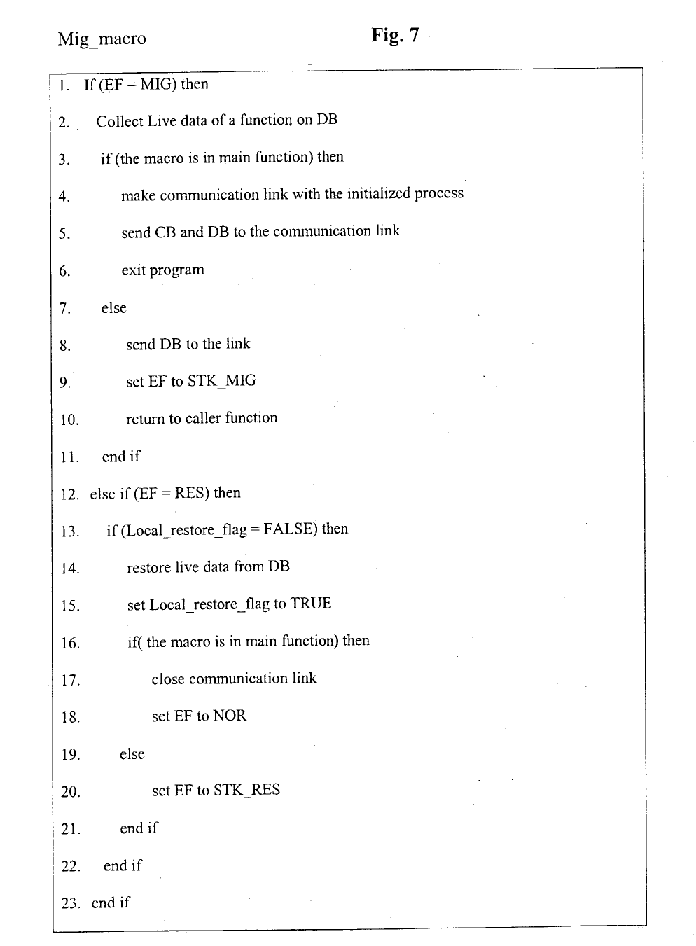

2. Mig_Macro: As seen in FIG. 7, the Mig_macro contains code for both data collection operations at the selected poll-point on the migrating process and data restoration operations at the selected poll-point on the initialized process. The macro performs the data collection operations when EF is set to MIG, and the data restoration operations when EF is RES. On the migrating process, when EF is MIG, the Mig_macro collects live-variable data at a selected poll-point, i.e., non-mandatory poll-point, and appends the data at the end of the DATA BUFFER. Then, if the function body that the macro has been annotated to is the main function, the macro will make a communication connection with the initialized process, send DATA BUFFER, and exit program. If the macro is not in the main function, it will send DATA BUFFER via the communication link, set EF to STK_MIG, and return to the caller function.

On the other hand, in case the macro is executing on the initialized process, if EF is set to RES prior to entering this macro (in Jump_macro, the Mig_macro starts restoring data. It first checks if the restoration on the function where the Mig_macro has been inserted to has already been done (indicated by the Local_restore_flag variable being set to TRUE). The Local_restore_flag is defined as a local variable of the current function set initially to FALSE. If so, it skips data restoration. Otherwise, the macro receives the portion of DATA BUFFER (transmitted via the communication link) that contains live-variable data of the migrating process, and then restores the data to the initialized process's memory space. The macro sets the Local_restore_flag to TRUE. If the restoration occurs on the main function, the EF is set to NOR and closes the communication link; otherwise, the macro sets EF to STK_RES. After that, the macro finishes its operations. The process execution continues on code within the function's body next to the Mig_macro.

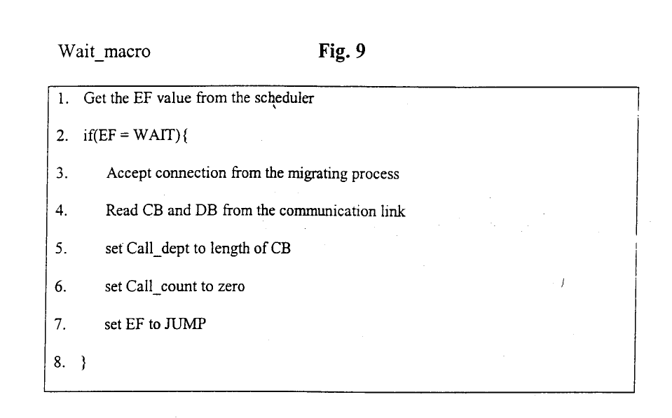

3. Stk_Macro: As seen in FIG. 8, the Stk_macro contains code for both data collection operations at the mandatory poll-point on the migrating process and data restoration operations at the mandatory poll-point on the initialized process. The macro performs the data collection operations when EF is set to STK_MIG, and the data restoration operations when EF is STK_RES. On the migrating process, when EF is STK_MIG, the Stk_macro collects live-variable data at a mandatory poll-point and appends the data at the end of the DATA BUFFER. Then, if the function body that the macro has been annotated to is the main function, the macro will make a communication connection with the initialized process, send CONTROL BUFFER and DATA BUFFER, and exit program. If the macro is not in the main function, it will send DATA BUFFER, set EF to STK_MIG, and return to the caller function.

On the other hand, in case the macro is executing on the initialized process, if EF is set to STK_RES prior to entering this macro (in mig_macro), the Stk_macro starts restoring data. It first checks if the restoration on the function where the Stk_macro has been inserted to has already been done (indicated by the Local_restore_flag variable being set to TRUE.) The Local_restore_flag is defined as a local variable of the current function set initially to FALSE. If so, it skips data restoration. Otherwise, the Stk_macro receives the portion of DATA BUFFER (transmitted via the communication link between the initialized process and the migrating process) that contains live-variable data of the annotated function, and then restores them to the initialized process's memory space. The macro sets the Local_restore_flag to TRUE. If the restoration occurs on the main function, the EF is set to NOR and close communication link. After that, the macro finishes its operations and the process execution continues on code within the function's body next to the Stk_macro.

4. Wait_Macro: As seen in FIG. 9, the wait macro first obtains the EF value from the scheduler. If the process is initialized, the EF is set to WAIT. The waiting process waits to accept communication connection from the migrating process. After the connection is established, the macro receives CONTROL BUFFER from the link, sets Call_depth variable to the length of CONTROL BUFFER (the number of Mp recorded in CONTROL BUFFER), and sets the Call_count variable to zero. These two global variables will be used for Jump_macro while restoring function call sequence (or process execution state). Finally, the macro sets EF to JUMP.

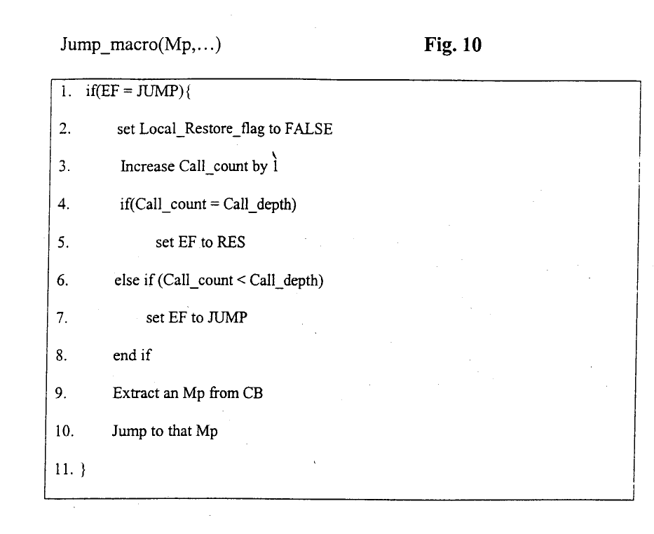

5. Jump_Macro: As seen in FIG. 10, this macro is used in the restoration operation to reconstruct the function call sequence as in the migrating process. The macro is activated only when EF is set to JUMP. It sets the Local_restore_flag to false and increases Call_count by 1. If Call_count is equal to Call depth, EF is set to RES. Otherwise, if Call_count is lesser than Call_depth, EF is set to JUMP. The macro extracts an element, Mp, out of the front of the CONTROL BUFFER, and then executes a goto statement to jump to the poll-point corresponding to the extracted Mp value.

The migration-enabling macros work together to support live-variable data collection, transfer, and restoration in the manner of the present invention. It will be appreciated that a key contribution of the present invention is that the above collecting, transferring, and restoring processes can be carried out concurrently so that the migration time is significantly reduced. In previous migration methods, these processes need to be carried out one-by-one, from collecting to restoring.

Memory blocks are usually identified by their address in a process. However, because different memory addressing schemes are used on different computer architectures, techniques must be used to logically identify the memory blocks for data collection and restoration between heterogeneous computers. In order to establish a migratable memory state, the present invention uses a buffered data transfer mechanism for data collection and restoration to support process migration in a heterogeneous or homogeneous environment as set forth in U.S. Pat. No. 6,442,663 to Sun et al., whereby the memory is converted from its native state in the process of the source machine into a logical memory state which can be migrated and reconstructed into a native state on the destination machine.

During process migration, the data collection mechanism is performed to collect the memory blocks in a process. When a memory block is encountered, the saving function is invoked according to the type of data values stored in the memory block. Then, the contents of the memory block are encoded into a machine-independent format and saved to an output buffer. After the output buffer is transmitted to the destination machine, the data restoration mechanism is operated. In turn, the migration mechanism invokes the restoring function to extract the contents of memory blocks, decode them to the machine-specific format of the destination machine, and store the decoded information to the appropriate native memory locations of the destination machine in the order required by the function state restoration function according to the present invention.

While certain exemplary embodiments have been put forth to illustrate the present invention, these embodiments are not to be taken as limiting to the spirit or scope of the present invention which is defined by the appended claims.

We claim:

1. A method for migration of an execution state and a memory state of a migrating process from a source computer to a destination computer in a networked computing system including the steps of:
a) collecting the execution and memory states from a migrating process in order from innermost function-to-outermost function;
b) transferring the execution and memory states to the destination computer;
c) restoring the execution and memory states in order from innermost function-to-outermost function; and
d) running the process on the destination computer.

2. The method of claim 1 wherein data transferred with the memory state is only live-variable data necessary to perform the migrated process on the destination computer.

3. The method of claim 1 wherein the step of transferring the execution and memory states to the destination computer includes collecting and transferring the execution and memory states in order from innermost function-to-outermost function.

4. The method of claim 1 wherein the step of restoring the execution and memory states and running the process on the destination computer includes restoring the execution and memory state and running the functions in an order from innermost-to-outer most functions.

5. The method of claim 2 further including the steps of:
a) constructing a machine independent, migration-enabled, executable which can track and collect a sequence of function operation in an order from innermost-to-outermost functions on the source computer and restore the sequence of function operation in the same order on the destination computer; and
b) collecting the live-variable data in an order from innermost to outermost functions on the source computer and restoring the live-variable data in the same order on the destination computer.

6. The method of claim 1 further including performing at least two of the steps of collecting, transferring, and restoring concurrently.

7. A method for migration of an execution state and a memory state of a migrating process from a source computer to a destination computer in a networked computing system including the steps of:
a) annotating poll points and migration-enabling macros at the poll points within a source code of a process on a source computer;
b) providing a machine-independent version of the annotated source code to the source computer and the destination computer;
c) migrating the migrating process to a destination computer, with the migration-enabling macros maintaining an order of collection and restoration of the execution state and memory state of the migrating process from innermost function-to-outermost function of the execution state; and
d) the migration-enabling macros performing a collection and restoration of the memory state to involve only live-variable data necessary to perform the migrated process on the destination computer.

8. The method according to claim 7 further including supplying an Entry_Macro migration-enabling macro for keeping track of the execution state on the migrating process.

9. The method according to claim 7 further including supplying a Mig_Macro migration-enabling macro for initiating the migration of the process and directing a data collection and restoration of live-variable data at a selected poll-point on the migrating process and at the destination computer, respectively.

10. The method according to claim 7 further including supplying a Stk_Macro migration-enabling macro for direct data collection and restoration of live-variable data at mandatory poll-points on the migrating process and at the destination computer, respectively.

11. The method according to claim 7 further including supplying a Wait_Macro migration-enabling macro for establishing a communication link with the migrating process, receiving CONTROL BUFFER contents, and starting restoration of the execution state.

12. The method according to claim 7 further including supplying a Jump_Macro migration-enabling macro for restoring the execution state of a process by reconstructing a function call sequence of the migrating process.

13. The method according to claim 7 further including the steps of automatically selecting poll points and automatically inserting migration-enabling macros in the source code by a pre-compiler.

14. The method according to claim 7 further including allowing users to select poll points at suitable migration locations in user source codes.

15. The method according to claim 14 wherein a poll-point analysis will annotate, at compile time, mandatory poll points at every function call statement made to a function within the process that has at least a selected poll-point defined at compile time to identify a sequence of function calls at runtime when a migration is performed at any selected poll point.

16. The method according to claim 7 wherein the annotation of the process comprises phases of program analysis and source code annotation mechanisms including program analysis techniques of poll point analysis and live-variable analysis.

17. Software for controlling migration of a process, the process including an execution state and a memory state, from a source computer to a destination computer in a distributed computing virtual machine, the virtual machine including a communication link between computers, the software comprising:
a) a precompiler for analyzing and annotating a source code of a process:
i) by inserting selected poll points, the selected poll points representing points where migration may occur within a function of the process source code, and
ii) by inserting mandatory poll points at function call points of the process; the mandatory poll points representing possible migration points, and
iii) by further inserting migration-enabling macros at each of the selected and mandatory poll points for tracking, collection, and restoration of function call sequences in the migration;
b) the precompiler further being capable of analyzing and annotating the data structure:
i) including means for cataloging the data structure of the process on the source computer, including tracking of live-variable data for each function within the process at live-variable definition points,
ii) including means for building a representation of a data structure of the first computer and converting the live-variable data from the data structure to a machine-independent logical structure including means to assign a variable to each memory block to track when the memory block has been accessed by the process for the use of its data,
iii) including means for cataloging the data structure of the process on the destination computer, including tracking of live-variable data for each function within the process at live-variable definition points,
iv) including means for converting the machine-independent logical structure of live-variable data transmitted from the source computer to the data structure on the destination computer, and assigning the data to appropriate live variables of each function; and
c) migration management macros, the migration management macros collecting the execution state and memory state in the order of inner function-to-outer function on the source computer and restoring the execution state and memory state in the order of inner function-to-outer function on the destination computer.

18. The software according to claim 17 further including an Entry_Macro migration-enabling macro for keeping track of the execution state on the migrating process.

19. The software according to claim 17 further including a Mig_Macro migration-enabling macro for initiating the migration of the process and directing a data collection and restoration of live-variable data at a selected poll-point on the migrating process and the destination computer, respectively.

20. The software according to claim 17 further including a Stk_Macro migration-enabling macro for direct data collection and restoration of live-variable data at mandatory poll points on the migrating process and the destination computer, respectively.

21. The software according to claim 17 further including a Wait_Macro migration-enabling macro for establishing a communication link with the migrating process, receiving CONTROL BUFFER contents, and starting restoration of the execution state.

22. The software according to claim 17 further including a Jump_Macro migration-enabling macro for restoring the execution state of a process by reconstructing a function call sequence of the migrating process.

23. The software of claim 17 wherein the migration-enabling macros for tracking, collection, and restoration of function call sequences in the migration can operate concurrently.

24. Software for enabling efficient migration of a migrating process from a source computer to a destination computer in a homogeneous or heterogeneous environment, including means for:
a) annotation of a source code of the process including:
i) selecting a number of poll point locations in the source code at which process migration can be performed,
ii) inserting at each poll-point location a label statement identifying the poll point and a macro for initiating migration operations wherein the macro will check whether a migration request has been sent to the process every time process execution reaches the poll-point location, and
iii) further including inserting at each poll-point location a live-variable definition detailing a presence of live-variable data necessary for executing a currently running function of the process;
b) executing the migration operation if a migration request has been received when the poll-point location is polled including:
i) collecting an execution state of the migrating process in order from inner-to-outer function,
ii) transferring the execution state from the source computer to the destination computer in order from inner to outer function, and
iii) collecting the live-variable data of the migrating process in order from inner-to-outer function,
iv) transferring the live-variable data of the migrating process to the destination machine in order from inner to outer function, and
v) restoring the execution state and live-variable data of the migrating process on the destination computer in order from inner to outer function.

25. The software according to claim 24 wherein the selecting of poll points and the inserting of macros are performed automatically by a pre-compiler.

26. The software according to claim 24 wherein collecting, transferring, and restoring processes of b)i)-b)v) can be carried out concurrently.

27. The software according to claim 24 wherein users may select poll points at suitable migration locations in user source codes.

28. The software according to claim 24 wherein the annotation of the source code comprises different phases of program analysis and source code annotation mechanisms, including program analysis techniques of poll-point analysis and live-variable analysis.

29. The software according to claim 28 wherein the poll-point analysis will annotate mandatory poll points at compile time at every function call statement made to the function that has at least a selected poll-point defined at compile time to identify a sequence of function calls at runtime when a migration is performed at any selected poll point.
